(19) United States
(12) Patent Application Publication
(10) Pub. No.: US 2006/0050503 A1
(43) Pub. Date: Mar. 9, 2006

(54) Illuminating module with a disk box storage function

(76) Inventor: Jack Lin, Taoyuan Hsien (TW)

Correspondence Address: Yi-Wen Tseng, 4331 Stevens Battle Lane, Fairfax, VA, 22033, US

(21) Appl. No.: 10/934,580

(22) Filed: Sep. 3, 2004

(51) Int. Cl. F21V 33/00; F21V 17/00

(52) U.S. Cl. 362/134; 362/441; 362/154

(57) ABSTRACT

An illuminating module with a disc box storage function is provided. It includes a base, a plurality of supporting poles, and at least one partition. The supporting poles stand vertically on four corners of the base. At least one partition is disposed on the supporting poles so that the disk boxes can be placed between the partition and the base or between every two partitions. Further, the conductive poles are respectively disposed at any two opposite sides of the base. The lower ends of the conductive poles are connected with the power supply inside the base so that the conductive poles are being a positive electrode and a negative electrode. In addition, the illuminator can be disposed on any one of the partitions. Also, the illuminator is connected with the top ends of the conductive poles so as to conduct electricity. Accordingly, the illuminator and a storage rack for disk boxes are combined into one without occupying too much space.

### BACKGROUND OF THE INVENTION

The present invention is related to an illuminating module with a disk box storage function, and more particularly, to an illuminating module including both the illuminator and the storage structure for disk boxes so that the storage rack for disc boxes and the lamp are combined, which not only saves the space, but also increases the convenience in use.

With the advance of modern technology, various kinds of multi-media information are stored in CD disks or DVD disks. These CD disks or DVD disks are usually kept in disk boxes to prevent from damages. However, since a disk box has a certain volume, the storage for these disk boxes would occupy more space. Presently, a storage rack for disc boxes is available in the market, as shown in FIG. 1. The storage rack 10a for disc boxes includes a base 1a, several supporting poles 2a, and a plurality of partitions 3a. The supporting poles 2a are vertically fixed and stand on proper positions on the base 1a. The plurality of partitions 3a are assembled on the supporting poles 2a and aligned with a same interval distance. Every two adjacent partitions 3a form a storage slot 31a so that the disk box 20a can be inserted into and placed in the storage slot 31a. Accordingly, multiple disk boxes 20a can be placed on the storage rack 10a orderly.

Generally, the storage rack 10a for disc boxes is placed near the multi-media equipment so that the user can easily reach the disk boxes. However, due to the occasional space limitation, it is not always easy to furnish the storage rack 10a in the house. Besides, the storage rack 10a for disc boxes often occupies too much space, which is not convenient enough. Therefore, how to combine the storage rack 10a with the furniture in the house in order to save more space has become a major problem waited to be solved in the industry.

On the other hand, the illuminating modules available in the market presently are mostly desk lamps or vertical lamp modules. The common illuminating module mainly includes a base, a supporting pole extending from the base and having a certain length, and an illuminator screwed on the top of the supporting pole. Further, a lampshade is usually provided for covering the illuminator. Accordingly, the common illuminating module has a certain volume and occupies too much available space in the house as well.

Therefore, how to combine the illuminating module with the storage rack 10a or other furniture in the house so as to provide additional value for the illuminating module and save more space, have become a major problem waited to be solved.

Accordingly, there exist inconvenience and drawbacks for practically applying the conventional illuminating module and the conventional storage rack 10a for disc boxes. There is thus a substantial need to provide an illuminating module with a disk box storage function that resolves the above drawbacks in the prior art.

### SUMMARY OF THE INVENTION

The present invention is to provide an illuminating module with a disk box storage function, which combines the lamp module and the storage rack for disc boxes. Accordingly, the lamp module and the storage rack for disc boxes are combined into one without occupying too much space.

In accordance with another aspect, the present invention is to provide an illuminating module with a disk box storage function, which combines the lamp module and the storage rack for disc boxes into one. Accordingly, the illuminating module has additional value and becomes multi-functional and the usage convenience is accordingly increased.

In accordance with the structural features of the present invention, the illuminating module includes a base, a plurality of supporting poles, and at least one partition. A power supply and a switch are disposed inside the base, while the supporting poles stand vertically on four corners of the base. The partitions are disposed on the supporting poles so that the disk boxes can be placed between the partition and the base or between every two partitions. The partition further includes a plurality of partition pieces aligned with a same interval distance. The storage slots are accordingly formed between every two adjacent partition pieces so that the disk boxes can be placed therein. Further, the conductive poles are respectively disposed at any two opposite sides of the base. The lower ends of the conductive poles are connected with the power supply inside the base so that the conductive poles are being a positive electrode and a negative electrode. In addition, the illuminator can be disposed above any one of the partitions. Also, the illuminator is connected with the top ends of the conductive poles so as to conduct electricity. Accordingly, an illuminating module combining a lamp module and a storage rack for disc boxes is accomplished.

According to another characteristic of the present invention, a lampshade is provided for covering the storage space where the illuminator is disposed. Further, since the lampshade is pervious to light, the illuminated light is projected outside the lampshade.

The foregoing and other features and advantages of the present invention will be more clearly understood through the following descriptions with reference to the drawings, wherein:

### BRIEF DESCRIPTION OF THE DRAWINGS

FIG. 1 is a diagram showing the outside appearance of the common storage rack for disk boxes according to the prior art;

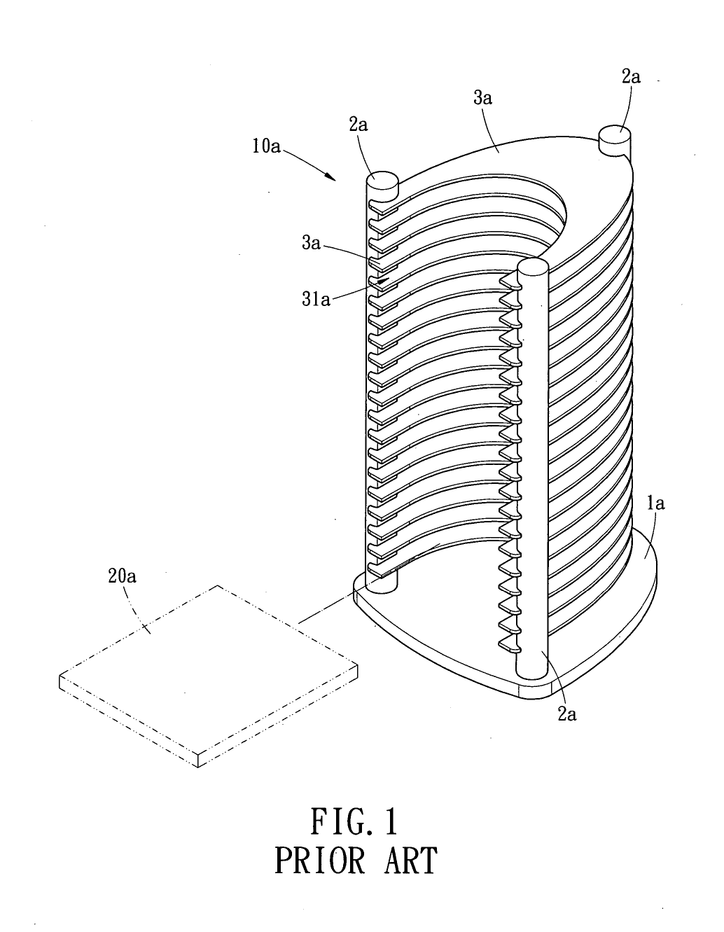

FIG. 2 is a an exploded view of the structure of the illuminating module according to one preferred embodiment of the present invention;

FIG. 3 is a diagram showing the outside appearance of the illuminating module according to one preferred embodiment of the present invention;

FIG. 4 is a cross sectional view showing the structure of the illuminating module according to one preferred embodiment of the present invention;

FIG. 5 is another cross sectional view showing the structure of the illuminating module according to one preferred embodiment of the present invention;

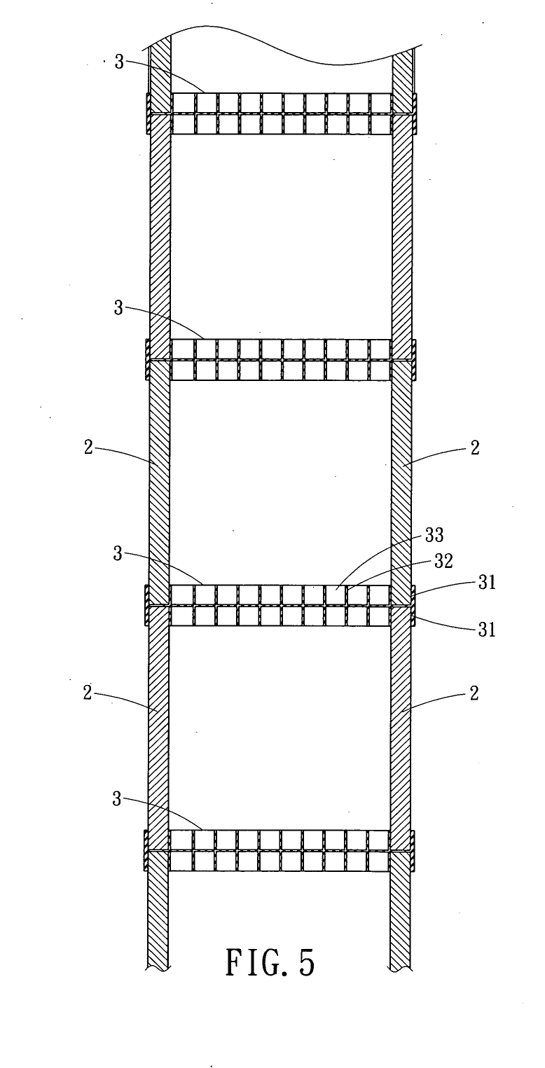

FIG. 6 is an enlarged diagram showing the A portion of FIG. 4;

FIG. 7 is an enlarged diagram showing the B portion of FIG. 4;

FIG. 8 is a diagram showing the outside appearance of the illuminating module with a lampshade according to one preferred embodiment of the present invention;

FIG. 9 is a cross sectional view showing the structure of the illuminating module according to another preferred embodiment of the present invention;

FIG. 10 is a cross sectional view showing the structure of the illuminating module according to another preferred embodiment of the present invention; and

FIG. 11 is a diagram showing the outside appearance of the illuminating module according to another preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

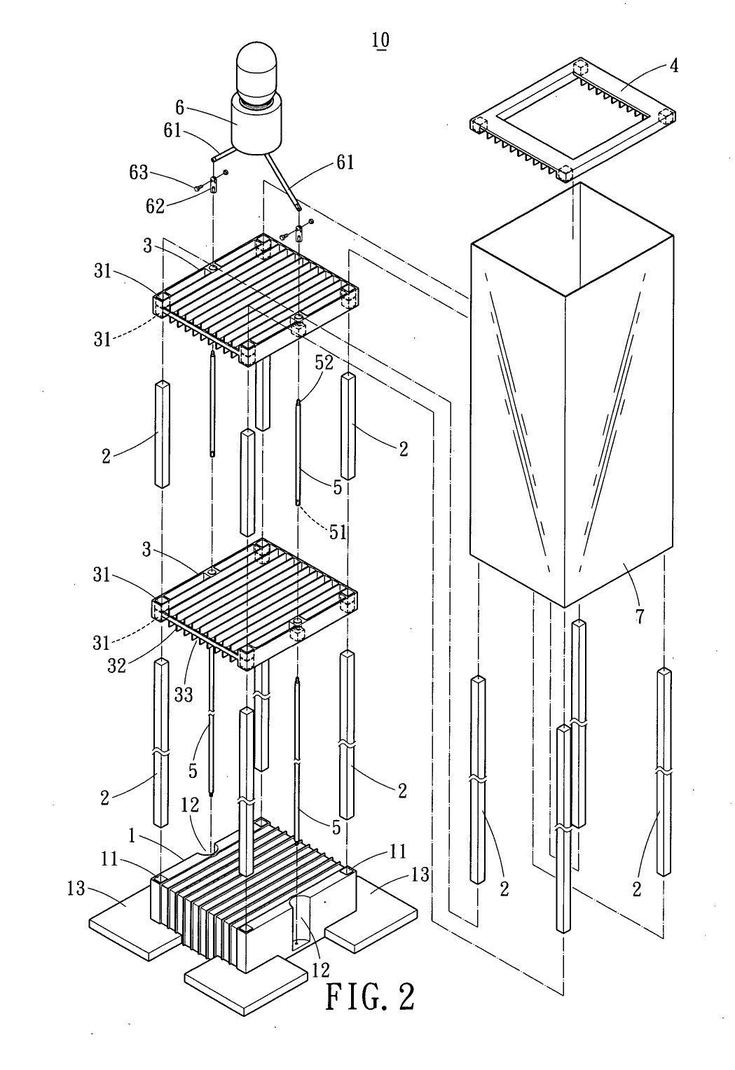

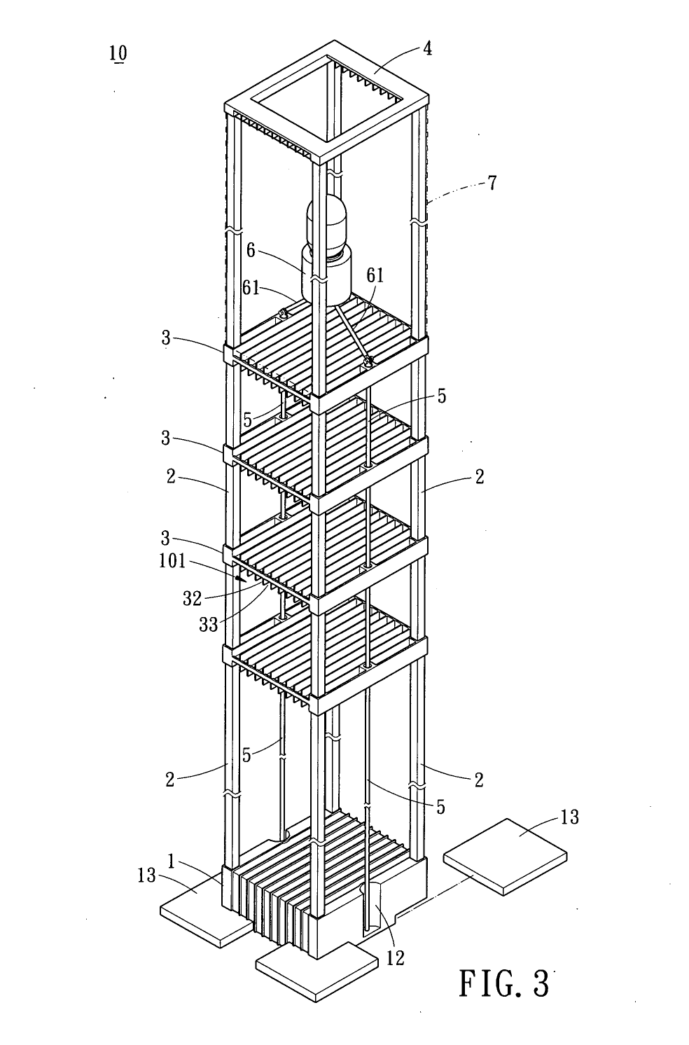

The present invention provides an illuminating module with a disk box storage function. Please refer to FIGS. 2-3. The illuminating module 10 includes a base 1. The assembly holes 11 are disposed at four corners of the base 1, and the base 1 further has two semicircular indentations 12 at any two opposite sides of the base 1. In addition, the base 1 includes supporting boards 13 extending outwards from the four corners of the base 1 so that the illuminating module 10 can stand on the floor steadily. The supporting boards 13 are detachable from the base 1 in order to be conveniently packed and transported. Also, a power supply and a switch are disposed inside the base 1.

In addition, the supporting poles 2 are vertically stand on four corners of the base 1 and connected therewith. The supporting poles 2 are inserted into the assembly holes 11. Through the supporting poles 2, at least one partition 3 is supported and disposed thereon. Both sides of the partition 3 include the linking openings 31 at four corners of the partition 3 for linking the supporting poles 2 therein. In this embodiment, the illuminating module 10 includes 5 layers of storage space 101. Preferably, the illuminating module 10 includes plural supporting poles 2 supporting one corner of the illuminating module 10. Certainly, the illuminating module 10 can also include a single one supporting pole 2 supporting one corner of the illuminating module 10. Further, the length of the supporting poles 2 varies according to the height needed for the storage space 101.

Please refer to FIGS. 2-3 continuously. In this embodiment, the illuminating module 10 includes 5 layers of storage space 101 which are composed of a base 1, four partitions 3 and a top board 4. The partition 3 includes plural partition pieces 32 at both sides of the partition 3 and the partition pieces 32 have a same interval distance between every two adjacent partition pieces 32. Every two adjacent partition pieces 32 form a storage slot 33 for placing the disk box 20 therein. Certainly, there are also partition pieces 41 disposed at the lower side of the top board 4 and having a same interval distance between every two adjacent partition pieces 41. Further, every two adjacent partition pieces 41 form a storage slot 42, and the top board 4 includes a plurality of openings for heat dissipating.

In addition, there are conductive poles 5 disposed at any two opposite sides of the base 1. The two conductive poles 5 have respective lower ends plugging into the two semicircular indentations 12 at any two opposite sides of the base 1. The lower ends of the conductive poles 5 are connected with the power supply for being a positive electrode and a negative electrode. The conductive pole 5 could be a single one conductive pole or composed of several conductive segments 5. In this preferred embodiment, one conductive segment 5 is connected in each storage space 101. Further, since the conductive pole 5 is low voltage and low current, an electric shock will not occur.

Please refer to FIG. 2. In this embodiment, an illuminator 6 is disposed above the toppest partition 3. That is, the illuminator 6 is disposed in the storage space 101 between the toppest partition 3 and the top board 4. The illuminator 6 is connected with two conductive pillars 61 extending from the illuminator 6. Through a fixing element 62 and a screwing component 63, the two conductive pillars 61 are respectively linked and engaged with the upper ends of the conductive poles 5 so that the power supply for the illuminator 6 is conductive.

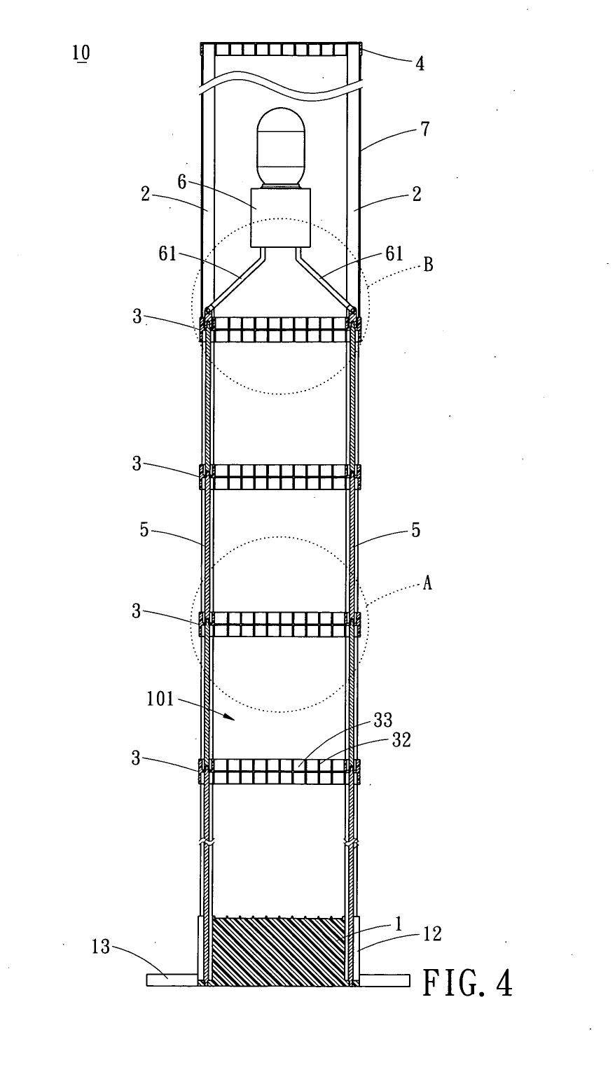

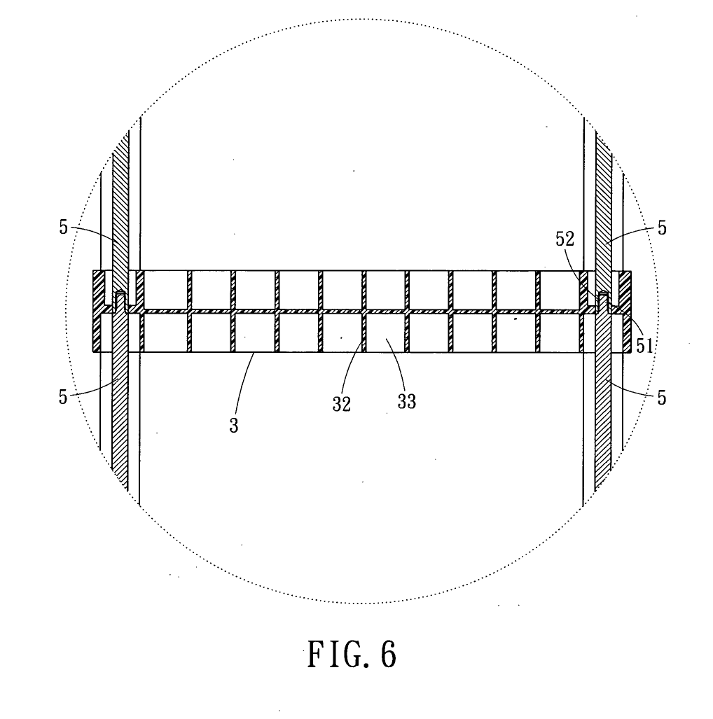

Please refer to FIG. 4. While assembling the supporting poles 2, the conductive poles 5 are assembled upwards at the same time. If the conductive poles 5 are composed of a plurality of conductive segments, the conductive segments 5 are connected together by a screwing step. As shown in FIG. 6, each of the conductive segments 5 includes a screw hole 51 at a lower end thereof and a screw post 52 at an upper end thereof. When assembling two conductive segments 5, the screw post 52 of one conductive segment 5 is screwed into the screw hole 51 of another conductive segment 5. Accordingly, two conductive segments 5 are connected.

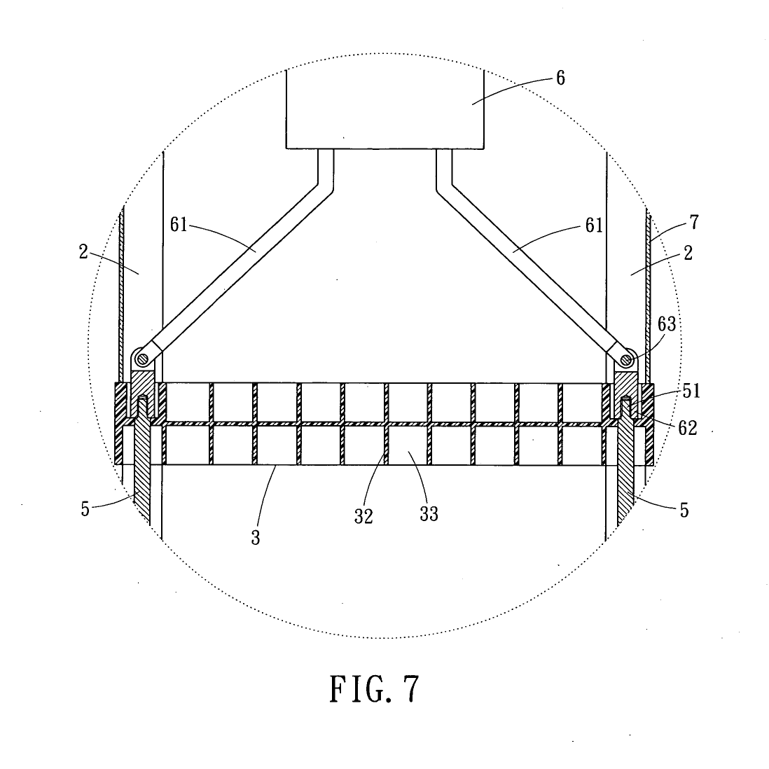

Please refer to FIG. 4 continuously. After the assembly of the supporting poles 2, partitions 3, top board 4 and the two conductive poles 5 is finished, the illuminator 6 is then assembled in the predetermined storage space 101. In the preferred embodiment, as shown in FIG. 7, the illuminator 6 is disposed in the toppest storage space 101. After the illuminator 6 is assembled in the illuminating module 10, the two conductive pillars 61 extending from the illuminator 6 are linked and engaged with the upper ends of the conductive poles 5 through the fixing element 62 and the screwing component 63 so that the power supply for the illuminator 6 is conductive. When the assembly of the illuminator 6 is finished, the illuminating module 10 with a disk box storage function as shown in FIG. 6 is accomplished.

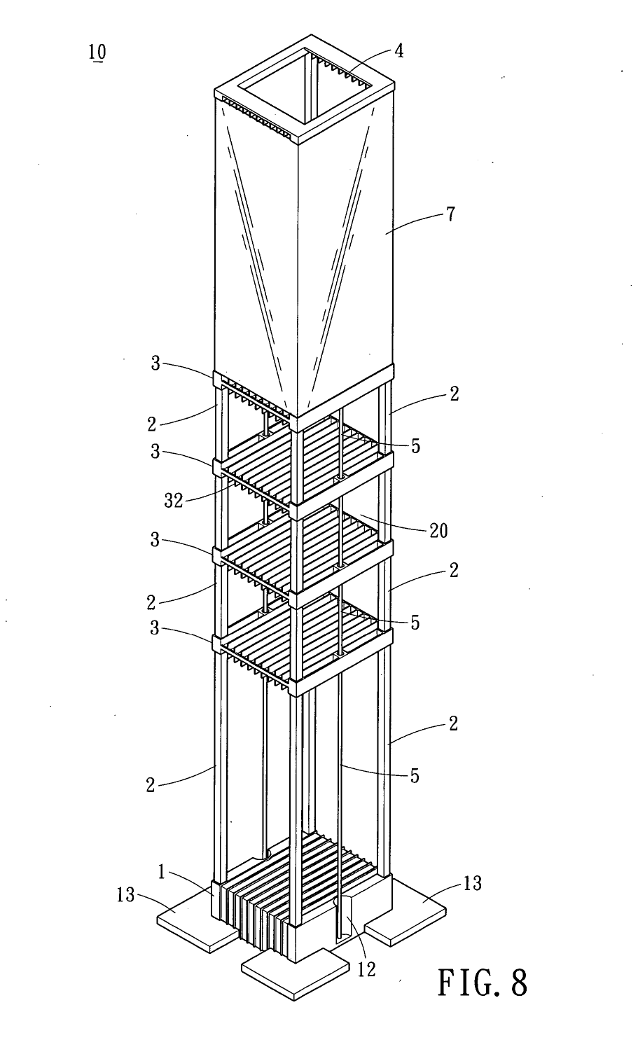

According to a preferred embodiment of the present invention, as shown in FIG. 8, a lampshade 7 is provided for covering the storage space 101 having the illuminator 6 therein. Since the lampshade 7 is pervious to light, the illuminated light from the illuminator 6 is projected outside the lampshade 7, which provides a better appearance for the illuminating module 10.

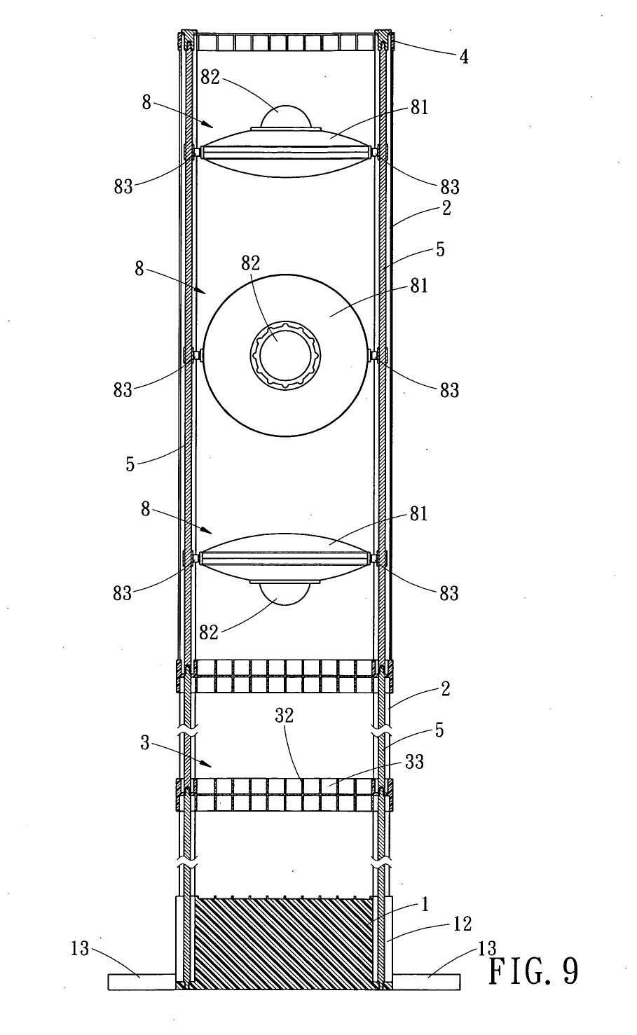

Please refer to FIG. 9 which shows another embodiment of the present invention. The illuminator is a plate-shaped lamp 8. The plate-shaped lamp 8 includes an elliptic lamp holder 81 and a light bulb 82 disposed on the elliptic lamp holder 81. Two conductive pillars 83 are disposed at two opposite lateral sides of the plate-shaped lamp 8. Also, each of the conductive pillars 83 has a slot-shaped opening at one end thereof so that the conductive pole 5 can pass through and disposed inside the slot-shaped opening of the conductive pillars 83. Preferably, the plate-shaped lamp 8 is rotatable so that the light direction therefrom is changeable. As shown in FIG. 9, there are three plate-shaped lamps 8 in the illuminating module 10, which have three different light directions for the convenience of the user.

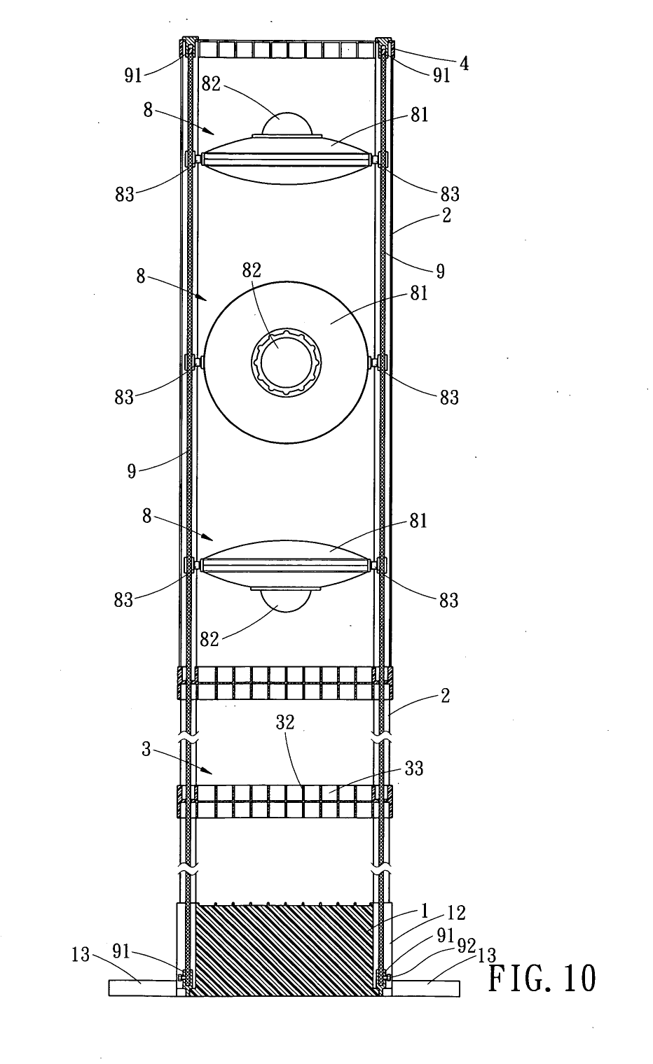

Please refer to FIG. 10 which shows another embodiment of the present invention. Preferably, the conductive poles 5 can be the cords 9. The cords 9 have an upper end and a lower end respectively fixed by a fixing element 91 and a screwing component 92. When the screwing component 92 at the lower end is screwed more tightly, the cords 9 will be tighter downwards in order to make the cords 9 fixed to the illuminating module 10.

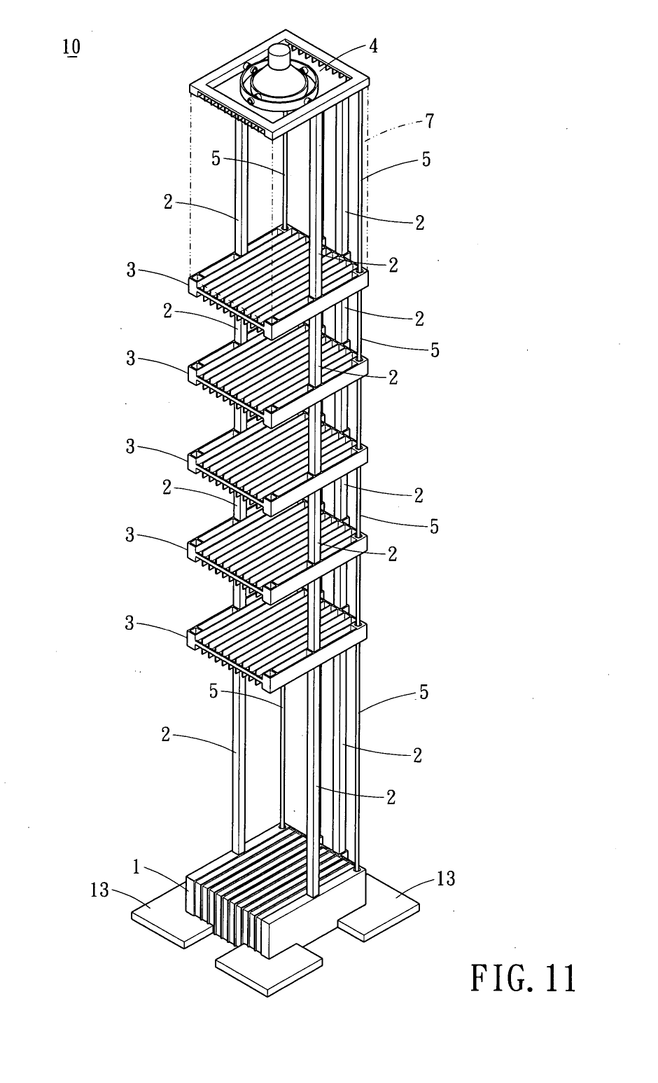

Please refer to FIG. 11 which shows another embodiment of the present invention. Preferably, the supporting poles 2 and the conductive poles 5 can be disposed at the back side of the storage space 101. As such, the outside appearance of the illuminating module 10 is beautified and it would be easier to place the disk box 20 inside the storage slots 33, 42.

From the above, it is known that the illuminating module 10 provided in the present invention combines an illuminator 6 and a storage rack for disk boxes together. Accordingly, an illuminator 6 and a storage rack for disk boxes are combined into one without occupying too much space. Therefore, the illuminating module 10 has the additional value of multi-function and it will be more convenient while being used. Hence, the present invention not only has a novelty and a progressive nature, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An illuminating module, comprising:
a base connected with a power supply and a switch;
a plurality of supporting poles vertically standing on and connected with the base;
at least one partition horizontally placed on the supporting poles so as to form a storage space between the partition and the base or between every two partitions for placing a disk box therein;
two conductive poles respectively being a positive electrode and a negative electrode, each having a lower end standing on the base and connected with the power supply and an upper end extending upwards to the storage space; and
an illuminator disposed in the storage space and connected with the positive electrode and the negative electrode.

2. The illuminating module according to claim 1, wherein the base comprises a plurality of assembly holes at four corners thereof for plugging the supporting poles thereinto, respectively.

3. The illuminating module according to claim 1, wherein the base has two semicircular indentations at two opposite sides thereof for plugging the lower ends of the two conductive poles thereinto, respectively.

4. The illuminating module according to claim 1, wherein the base further comprises a plurality of supporting boards extending from the four corners thereof respectively, and the supporting boards are detachable from the base.

5. The illuminating module according to claim 1, wherein both sides of the partition comprise a plurality of linking openings at four corners thereof for linking the supporting poles therein respectively.

6. The illuminating module according to claim 5, wherein the partition comprises a plurality of partition pieces aligned at both sides of the partition with a same interval distance between every two adjacent partition pieces.

7. The illuminating module according to claim 6, wherein every two adjacent partition pieces form a plurality of storage slots in the storage space for placing the disk box therein.

8. The illuminating module according to claim 1, wherein the two conductive poles are respectively assembled by connectedly screwing a plurality of conductive segments together.

9. The illuminating module according to claim 9, wherein each of the conductive segments comprises a screw hole at a lower end thereof and a screw post at an upper end thereof so that two conductive segments are assembled by screwing the screw post of one conductive segment into the screw hole of another conductive segment.

10. The illuminating module according to claim 1, wherein the conductive pole provides low voltage and low current.

11. The illuminating module according to claim 1, wherein the illuminator is connected with two conductive pillars extending therefrom, and the two conductive pillars are respectively linked and engaged with the upper ends of the conductive poles by a fixing element and a screwing component.

12. The illuminating module according to claim 1, further comprising a lampshade for covering the storage space having the illuminator therein, wherein the lampshade is transparent for light.

13. The illuminating module according to claim 1, further comprising a top board located on the top of the supporting poles, wherein the top board comprises a plurality of openings for heat dissipating.

14. The illuminating module according to claim 1, wherein the illuminator is a plate-shaped lamp comprising an elliptic lamp holder and a light bulb disposed on the elliptic lamp holder.

15. The illuminating module according to claim 14, wherein two conductive pillars are disposed at two opposite lateral sides of the plate-shaped lamp and each of the conductive pillars has a slot-shaped opening at one end thereof for being connected with the conductive pole.

16. The illuminating module according to claim 1, wherein the conductive poles are cords having an upper end and a lower end respectively fixed by a fixing element and a screwing component.

17. The illuminating module according to claim 16, wherein when the screwing component at the lower end is screwed more tightly, the cords will be tightened downwards in order to make the cords securely fixed.
